(19) United States
(12) Patent Application Publication
(10) Pub. No.: US 2005/0140070 A1
(43) Pub. Date: Jun. 30, 2005

(54) Method of manufacturing metal- or ceramic microparts

(76) Inventors: Guido Finnah, Karlsruhe (DE); Jurgen Hausselt, Germersheim (DE); Niis Holstein, Karlsruhe (DE); Thomas Johann, Dr. Weddigen (DE); Volker Piotter, Linkenheim (DE); Robert Ruprecht, Walzbachtal (DE); Gerhard Schanz, Eggenstein-Leopoldshafen (DE)

Correspondence Address: KLAUS J. BACH, 4407 TWIN OAKS DRIVE, MURRYSVILLE, PA, 15668, US

(21) Appl. No.: 11/053,017

(22) Filed: Feb. 8, 2005

Related U.S. Application Data
(63) Continuation-in-part of application No. PCT/EP03/08026, filed on Jul. 23, 2003.

(30) Foreign Application Priority Data
Aug. 10, 2002 (DE) 102 36 812.0

(51) Int. Cl. B29C 33/40

(52) U.S. Cl. 264/636; 264/219

(57) ABSTRACT

In a method of manufacturing metallic or ceramic microparts using a three-dimensional body formed by first and second polymer fractions in a two-component injection molding process, wherein one of the polymer fractions comprises an electrically non-conductive polymer and the second an electrically conductive polymer, the polymer fraction used for the first injection molding step has a higher melting point than the polymer fraction used in the second injection molding step and the metal micropart is formed by galvanic deposition of a metal from an electrolyte and the ceramic micropart is formed by electrophoretic deposition of ceramic material from a ceramic suspension or colloid on the electrically conductive polymer fraction surface of a substrate surface of the interim body.

This is a Continuation-In-Part Application of International Application PT/EP03/08026 filed and claiming the priority of German application 102 36 812.0 filed Aug. 10, 2002.

### BACKGROUND OF THE INVENTION

The invention resides in a method of manufacturing metal- or ceramic microparts which include electrically conductive sections.

One way of manufacturing metal- or ceramic microparts involves the manufacture of a polymer body as a negative die structure including an at least partially electrically conductive surface. In a further step, a metal micropart is formed on the polymer body by galvanic deposition of a metal from an electrolyte, or a ceramic micropart is formed by electrophoretic deposition of a ceramic material from a ceramic suspension or colloid on the electrically conductive surface areas of the polymer body which serve as an electrode. This step is also called galvanic-forming or electrophoresis. Subsequently, the polymer body and the metal or ceramic micropart are separated preferably by dissolution of the polymer die body in a solvent. The die body employed in this process is therefore also designated a “lost die”.

For a high-quality reproducible manufacture of metallic or ceramic microparts by the described galvanic or electrophoretic deposition procedure, it is very important to avoid inclusions, voids or other material inhomogeneities. It is noted that the galvanic or electrophoretic deposition rate increases with the field line density. If, for example, several projecting structures with an electrically conductive surface are provided close together on the mold body the galvanic or electrophoretic deposition occurs preferentially on the projecting structures and may even result in a complete covering of the areas between the projecting structures and consequently in an elimination of these areas from the deposition process. In most cases, undesirable enclosures or voids are formed in these areas from rests of the electrolyte or, respectively, suspension or colloids used.

In order to avoid such effects the electrically conductive surface and, consequently, the galvanic or electrophoretic deposition of a metallic or ceramic material must be limited to certain areas of the die or mold body. Projecting, electrically non-conductive structures extending from an electrically conductive surface of a substrate result for example in a deposition of the metal or ceramics on the substrate surface selectively and with a constant deposition rate and, after a certain time, in a slow and faultless covering of the structure by the deposited metal or ceramic material.

In V. Piotter, R. Ruprecht, J. Schröck: Verfahren zur Herstellung von LIGA-Metallmikrostrukturen durch Galvanoformung in verlorene Kunststoffformen:Jahrbuch Oberflächentechnik, Vol. 52 (1996) 33-44, several methods for the manufacture of metal microparts by galvano-forming in lost plastic molds are described. As alternatives for the manufacture of the lost molds injection molding, hot transforming as well as reaction casting are mentioned. In connection with injection molding an electrically conductive surface, a metal layer is deposited on the finished die body by a sputtering process, wherein upright structure surfaces are coated with layers of smaller thickness resulting in a larger electrical resistance. In the hot transformation process, on the other hand, sputtered plastic surfaces are structured by hot transformation that is by stamping, wherein the sputter layer is also pressed in and ruptures in the areas of the upstanding structures. In a third disclosed process, the relatively expensive reaction casting is described wherein non-conductive structures of a reaction casting resin are applied to an electrically conductive substrate.

The quality of the lost die or mold is important for a fault-free manufacture of metal or ceramic microparts by galvanic forming or by electrophoresis. Ideally, the structures are electric insulators which are deposited on a substrate having a surface of good electric conductivity. Ruptured sputter layers as provided mainly with the hot forming process described above can lead to local material inhomogeneities, enclosures or voids. The reaction casting process fulfills the mentioned basic electrical conditions but is expensive. In addition, the reaction casting resin must be prevented reliably from covering the electrically conductive substrate.

It is the object of the present invention to provide a method for the manufacture of metallic or ceramic microparts which does not have the disadvantages and limitations of the processes described above.

### SUMMARY OF THE INVENTION

In a method of manufacturing metallic or ceramic microparts using a three-dimensional mold body formed by first and second polymer fractions in a two-component injection molding process, wherein one of the polymer fractions comprises an electrically non-conductive polymer and the second an electrically conductive polymer, the polymer fraction used for the first injection molding step has a higher melting point than the polymer fraction used in the second injection molding step and the metal micropart is formed by galvanic deposition of a metal from an electrolyte and the ceramic micropart is formed by electrophoretic deposition of ceramic material from a ceramic suspension or colloid on the electrically conductive polymer fraction surface of a substrate surface of the mold body.

The basic steps comprise the manufacture of an interim die body from one of the two polymer fractions by an injection molding process in a first evacuated cavity of a multi-part injection molding tool. This is followed by an exchange of at least one part of the injection molding tool by at least one other injection molding tool part, wherein the interim die body remains in the remaining part of the injection molding tool and forms with the remaining and the other parts of the injection molding tool at least one second cavity. In a third basic process, then another polymer is injected into the second cavity which may first be evacuated. Then the metal micropart is built up by the galvanic deposition of a metal from an electrolyte or the ceramic micropart is built up by electrophoretic deposition of a ceramic material from a ceramic suspension or colloid beginning with the electrically conductive polymer fraction on the substrate surface serving as an electrode.

Two-component injection molding processes for the manufacture of dies are known as such, but they have disadvantages which exclude their use for the manufacture of dies for galvanic forming in micro-dimensions because of the properties mentioned earlier. In order to avoid possible weak areas, in the two-component injection molding procedure two mixable polymers are used, preferably polymers of the same polymer base, which easily melt together in the transition areas during the second injection molding process.

This results in a local intermixing of the polymer fractions which, particularly in the micro-size range, can easily reach an unacceptable extent in relation to the dimensions of the die body. A sufficient separation between an electrically conductive and an electrically non-conductive polymer fraction can consequently not be ensured.

Optionally, therefore, a modified two-component injection molding process for the manufacture of the micro-die body, wherein, for the second injection molding procedure, the injection molding tools used and the mold inserts are heated together with the interim die body to a temperature close to the melting temperature of the other of the two polymer fractions. The polymer fraction injected in the first injection molding procedure has a higher melting point than the polymer fraction injected in the second injection molding step. In this way, intermixing of the polymer fractions is avoided or reduced in a simple and advantageous manner.

Preferably, two polymer fractions are injected which, under the process conditions, are not, or only conditionally, soluble in one another or polymer fractions with different melting points are used so that the polymer fractions are not intermixed. The mechanical stability of the die or mold body is consequently to be established by form—and, preferably force interlocking. In each case, however, a tight contact of the connections is to be established in order to reliably prevent the infiltration of electrolyte components during galvanic forming. Therefore the polymer fraction used in the second injection procedure has a higher thermal expansion coefficient and/or a higher melting or solidification point than the first polymer fraction.

The polymer fractions used are based for example on the polymers polyethylene (PE), polyoxymethylene (POM), polyamide (PA), polymethylmethylacrylate (PMMA), polyetheretherketone (PEEK), liquid crystal polymer (LCP, Liquid Crystalline resin) or a thermoplastic polymer. The electrically conductive polymer fraction furthermore contains a conductive filler. A pre-condition for a galvanic deposition is that the specific resistance is smaller than 1000 Ω; for a reliable generation of a closed galvanic coating by way of an area seed formation, a resistance of less than 300 Ω/cm is to be adjusted empirically or by way of a percolation calculation. As filler, basically all electrically conductive materials are suitable, particularly carbon-containing powder such as black carbon, graphite or carbon fibers.

Generally, the interim die body can be produced from the electrically conductive or the electrically non-conductive polymer fraction.

If the interim body consists of an electrically conductive polymer fraction, it must be held during the second injection process between the parts of the injection molding tool used in that case or the die inserts in order to avoid that the electrically conductive substrate surface is covered by the electrically non-conductive polymer fraction. In this way, additionally the die inserts cannot be damaged. The electrically conductive substrate surfaces or at least the largest part thereof need to be safely and sealingly covered in the area of the projecting structures by the die inserts or injection molding tools. Basically, it is possible to use the part of the substrate surface which is completely covered by parts of the injection molding tool as part of a clamping surface between the injection molding tool and the interim die body.

The manufacture of metal micro-parts by galvanic forming in the field of micro-system engineering generally requires die bodies with a plate-like substrate and microstructures extending from one side of the substrate. Therefore, it may be advantageous if, in a first injection molding process step, a plate-like interim die body is formed which has openings which, in the second injection molding process, serve as engagement castings to the upstanding structures.

It is within the scope of the present invention to manufacture the interim die body not in connection with the first injection molding procedure but to integrate it as pre-finished part into the injection molding tool or in the die insert.

Alternatively, the interim die body is manufactured by the first injection molding procedure using the electrically non-conductive polymer fraction wherein the projecting structures are part of the interim body. The interim body could comprise several separable interim body parts wherein casting parts could be removable together with parts of the injection molding tool or mold inserts which have to be removed or exchanged for the second injection molding procedure.

Below the invention will be described on the basis of examples with reference to the accompanying drawing.

### BRIEF DESCRIPTION OF THE DRAWINGS

FIGS. 1 a-e show schematically the sequence of a method for the manufacture of a metal micropart in accordance with a first example of the procedure,

FIGS. 2 a-c show schematically the sequence of a method for the manufacture of a metal micropart in accordance with a second example of the procedure, and

FIGS. 3 a-c show various design alternatives for the die body in the area of the projecting structures thereof in a cross-sectional view.

### EXAMPLE 1

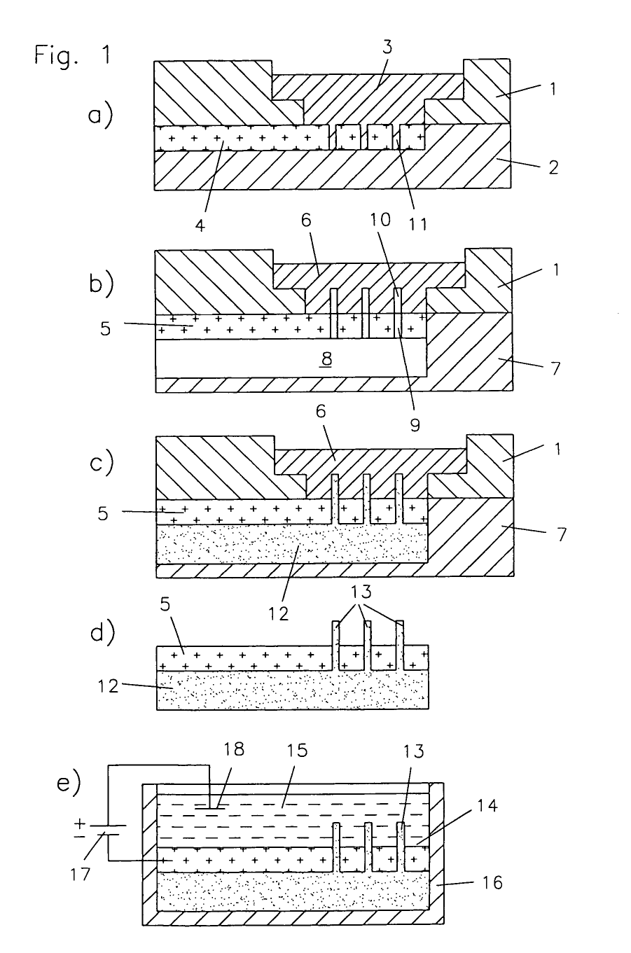

A method of manufacturing a metal micropart in accordance with a first exemplary procedure as shown in FIGS. 1a to 1c comprises the manufacture of a lost die body with an interim body consisting of an electrically conductive polymer.

FIG. 1 shows an upper part 1 and a lower part 2 of an injection molding tool and an insert member 3 disposed in the upper part tool and an insert member 3 disposed in the upper part 1 of the tool for a first injection molding procedure. The cavity between the insert member 3 and the lower part 2 of the injection molding tool is filled in the first injection molding step by a molding material batch 4. As molding material, an electrically conductive polymer fraction is used, in the example polyamide 6.6 mixed with carbon fibers (30% carbon fibers with a diameter of 5 to 7 μm and a length of 3 to 6 mm) as conductive filler material. With a minimum diameter of the projecting structures 11 in the mold insert 3 of 260 μm and an aspect ratio, that is the ratio of the height of the structures to the maximum width of the structure, of 5, for the first injection molding procedure in the present example a molding material temperature of about 280° C. and a tool temperature of about 120° were selected. After the first injection molding procedure, the molding material cools down in the mold insert 3 and in the injection molding tools 1 and 2 to form an interim molded body 5 (see FIG. 1b). The structures on the mold insert 3 are provided so as to form passages 9 in the interim molded body 5.

FIG. 1b shows the injection molding tool changed over ready for the second injection molding step. To this end, the mold insert 3 has been replaced by a second different mold insert 6 with microcavities 10 in place of the projecting structures and the lower part of the injection molding tool has been replaced by a second lower part 7 forming a second cavity 8. The second mold insert 6 is so positioned over the interim molded body 5 that the passages 9 in the interim body 5 are in alignment with the microcavities 10 of the second mold insert 6 such that the microcavities 10 accurately overlay the passages 9. In the given example, the opening diameter of the microcavities is 300 μm.

Then, in the second injection molding procedure according to FIG. 1c, an electrically non-conductive polymer fraction 12 is injected into the second cavity 8, which comprises also the passages 9 and the microcavities 10. With the use of polyoxymethylene (POM), a molding material temperature of about 200° C. is established. The molding material flows from the second cavity 8 through the passages 9 in the interim molded body 5 into the microcavities 10 of the second mold insert 6. To this end, with POM, a specific injection pressure of about 900 bar is selected. It is advantageous to use for that purpose a so-called variotherm process which provides for the heating of the injection molding tool and the mold insert, in the present case to about 150° C., that is, the tool is heated to a temperature close to the melting temperature of the injected molding material.

It is important that, in the second injection molding step, the mold insert 6 is sealingly disposed on the interim molded body 5. Furthermore, the cavity must be evacuated before the injection of the second polymer fraction. In this way, the second polymer fraction is prevented from entering between the interim molded body 5 and the mold insert 6 where it would cover the electrically conductive surface of the interim body 5 and insulate it. An electrically insulating cover of the electrically conductive surface would then not be available for the subsequent galvanic forming as no electrode surface would be present as deposition surface.

For the removal of the molded body from the molding tool comprising the electrically conductive interim body 5, the second electrically non-conductive polymer fraction 12 and the non-conductive projecting structures 13 (see FIG. 1d) the tool is cooled down to about 90° C.

Subsequently, the molded body is transferred preferably without additional working in the area of the projecting structures 13 to a bath consisting of an aqueous electrolyte 15 in a container 16 and connected to a voltage supply 17 with an anode 18 (FIG. 1e). The free surface of the interim molded body 5 serves in the area of the projecting structures 13 as a substrate 14. The substrate 14 serves during the galvanic forming as an electrode (cathode, i.e. negative pole) on which metal is galvanically deposited from the aqueous electrolyte 15 by a reduction of metal ions. The projecting structures 13 formed by the non-conductive polymer fraction are consequently, inverted into the deposited metal that is, they are negatively copied. To this end, a sufficient electric surface conductivity of the electrically conductive resin fraction, that is, of the interim molded body 5 or, respectively, the substrate 14 is to be ensured.

### EXAMPLE 2

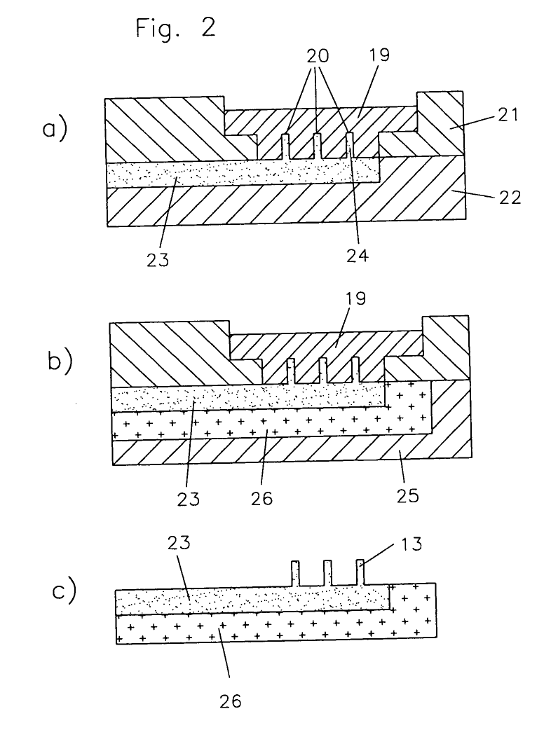

A method for the manufacture of a metal micropart comprises according to the second example as shown in FIGS. 2a to 2c, the manufacture of a lost molded body, wherein the interim body is made from an electrically non-conductive polymer.

In this example, in a first injection molding step as shown in FIG. 2, a mold insert 19 having microstructures 20 inserted therein and an upper and a lower injection molding tool part 21 and 22, a first casting material of an electrically non-conductive polymer fraction is injected as mold material into an evacuated and heated first cavity formed between the upper and the lower injection molding tool parts and solidifies therein to form an interim mold body 23 with projecting structures 24. The mold inserts and the injection molding tools shown in the example are so formed that an interim mold body is formed which comprises several comb-like interim mold body parts which extend parallel to each other and are interconnected at one of their ends. The connection can be such that they can be removed of the first injection molding step. The comb-like structures extend between the projections also to substrate areas wherein the surface is formed locally by the electrically non-conductive polymer fractions. During the galvanic deposition, they grow, starting from the electrically conductive surface areas such as the projecting structures, by the metal galvanically deposited thereon.

By the injection of a molding material, in the present case, polymethylmetacrylate (PMMA), the cavity and also the microstructures 20 are filled. Typical injection parmeters for PMMA are a molding material temperature of 230° C. and a tool temperature during injection of about 130° C. The specific injection pressure is 850-900 bar.

When the interim body 23 has cooled down, the lower injection molding tool part 22 is replaced by a second lower molding tool part 25. The second cavity formed thereby is filled in a second injection molding step (FIG. 26) with a molding material of an electrically conductive polymer fraction 26, for example, polyamide 12 (PA12) and 15-20% conductive carbon. Typical injection parameters for PA 12 filled with black carbon are 250° for the molding material and 130° C. for the tool. In this example, for the PA12, a variotherm procedure is not needed. However, the tool temperature must be lowered to about 90° C. in order to facilitate the removal of the PMMA structures. (Variotherm process) The specific injection pressure is about 800 bar. Basically, for achieving a satisfactory injection molding result, the cavities should also be evacuated like in the injection molding process of the first example, and the injection molding tools and the inserts should be heated.

When the PMMA and PA12 has cooled down, the molded part with projecting structures shown in FIG. 2c without the mold insert and without molding tool, is removed from the moldng tool and preferably transferred without after-treatment to a galvanic treatment location which is essentially the same as described in connection with example 1 (see FIG. 1a).

In comparison with the first example, in the second example, in the first injection molding step, the interim body is cast together with the projections. In this way, the exchange of the molding insert 19 before the second injection molding step is omitted and consequently also a possible source for an undesired covering of the electrically conductive substrate by the electrically non-conductive polymer fraction. Still, it is also in the second example very important to prevent intrusion of electrically non-conductive polymer parts into the interface between the mold insert 19 and the lower injection molding tool part 22 during the first injection molding step. This can be achieved by a compression of the mold insert and the injection molding tool. The intrusion of the molding material would result in an undesirable cover-up of the electrically conductive substrate by an insulating coating.

In the second example, the electrically conductive polymer fraction should have a higher coefficient of expansion than the electrically non-conductive polymer fraction, so that the comb-like structures formed in the second injection molding step are additionally firmly engaged by the electrically conductive polymer fraction. In this way, additional protection against an undesired intrusion of the aqueous electrolyte into the interface area between the two polymer fractions of the molded body during the galvanic deposition is provided, particularly if the two polymer fractions are not soluble within one another.

In the first example, the electrically non-conductive polymer fraction extends through the electrically conductive interim body to the projecting structures (see FIG. 1d). In the case, wherein the two polymer fractions are not soluble within one another, a rivet-like joint structure is formed in this way.

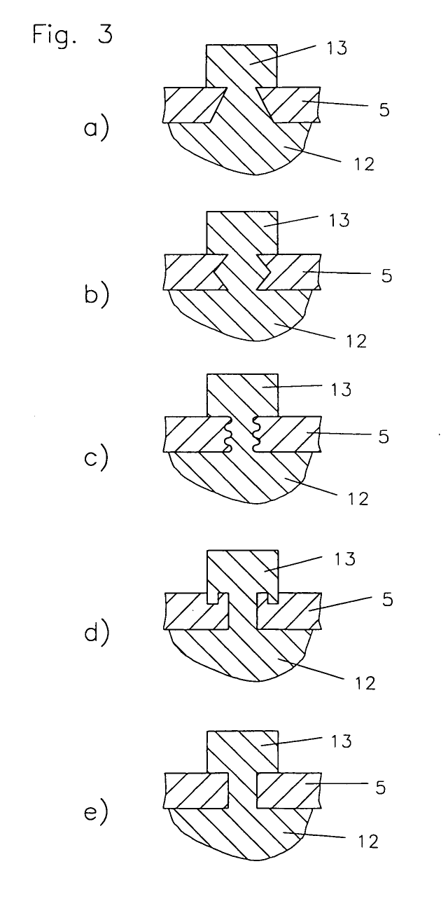

FIGS. 3a to 3e shows alternative arrangements for such a joint structure wherein only the area of jointure of a single projecting structure 13 with the interim body 5 is shown in each case. Shown are: a conical (FIG. 3a), a double-conical (FIG. 3b), a waved (FIG. 3c) jointure, a barbed jointure (FIG. 3a) and a jointure with rough engagement surfaces (FIG. 3e). The reason for such an arrangement is that the intrusion of electrolytes into the interface area between the two polymer fractions of the molded body must be reliably prevented. A heat expansion of the electrically non-conductive polymer fraction with respect to that of the interim body results in a very tight engagement of the projecting structures on the interim body.

1. A method of manufacturing metallic or ceramic microparts comprising the steps of:
a) manufacturing, by a two-component injection molding procedure, a three-dimensional molded body consisting of a substrate with a substrate surface and, projecting therefrom, structures consisting of a first polymer fraction, and a second polymer fraction disposed on the substrate surface at least in the area around the projecting structures, the three-dimensional body being formed by
1) providing a multipart injection molding tool with an insert defining a first cavity which is evacuated, and injecting, in a first injection molding step, the first polymer fraction into the first cavity to form an interim molded body,
2) exchanging at least one part of the injection molding tool with another part while the interim molded body remains in position in the remaining parts of the injection molding tool and defines therewith and with the exchanged molding tool part, a second cavity,
3) evacuating the second cavity and injecting the other of the two polymer fractions into the evacuated second cavity in a second injection molding step,
4) the first polymer fraction being electrically non-conductive and the second polymer fraction being electrically conductive, and
b) depositing on the three-dimensional body by one of galvanic deposition of a metal from an electrolyte and deposition of a ceramic material from a ceramic suspension or colloid, on the electrically conductive polymer fraction on the substrate of the three-dimensional interim body to form the metal or respectively ceramic micropart thereon.

2. A method of manufacturing metallic or ceramic microparts according to claim 1, wherein, for the second injection molding step, the remaining and the replacement molding tool parts are heated, together with the interim body consisting of one polymer fraction to a temperature close to the melting point of the other of the two polymer fractions, the one polymer fraction having a higher melting point than the other polymer fraction.

3. A method of manufacturing microparts according to claim 2, wherein the polymer fraction injected in the first injection molding step is the electrically conductive polymer fraction.

4. A method according to claim 3, wherein the interim molded body is firmly engaged during the second molding step between the new and the remaining parts of the injection molding tool and the interim molded body has surface areas which form the largest part of the substrate surface in the area of the projecting structures and parts of the injection molding tool completely cover the part of the substrate surface.

5. A method according to claim 4, wherein the part of the substrate area which is completely covered by parts of the injection molding tool forms an engagement surface for engaging and firmly holding the interim body in the injection molding tool.

6. A method according to claim 3, wherein the interim body includes openings which, during the second injection molding step, provide for a jointure between the other polymer fraction injected into the second cavity and the projecting structures.

7. A method according to claim 1, wherein the first polymer fraction has a higher thermal expansion coefficient than the second polymer fraction.

8. A method according to claim 1, wherein the interim body formed in the first injection molding step from the electrically non-conductive polymer fraction comprises the projecting structures.

9. A method according to claim 8, wherein the interim body comprises several separable interim body parts.

10. A method according to claim 8, wherein the second polymer fraction has a higher thermal expansion coefficient than the first polymer fraction.

11. A method according to claim 1, wherein each of the first and the second polymer fractions are based on one of the polymers: polyethylene (PE) polyoxymethylene (POM) and polyamide (PA).

12. A method according to claim 1, wherein the second polymer fraction contains an electrically conductive filler material.

13. A method according to claim 12, wherein the electrically conductive filler material is at least one of carbon black, graphite and carbon fibers.
